(19) United States
(12) Patent Application Publication
(10) Pub. No.: US 2017/0027202 A1
(43) Pub. Date: Feb. 2, 2017

(54) Preparation Of Meat Jerky

(71) Applicant: Michelle Denise Timberlake, Jachin, AL (US)

(72) Inventor: Michelle Denise Timberlake, Jachin, AL (US)

(21) Appl. No.: 15/221,581

(22) Filed: Jul. 27, 2016

Related U.S. Application Data
(60) Provisional application No. 62/197,590, filed on Jul. 28, 2015.

(51) Int. Cl. A23L 13/70

(52) U.S. Cl. CPC A23L 13/72; A23V 2002/00

(57) ABSTRACT

A method for preparing meat jerky is provided. A whole slab of raw meat is sliced into multiple whole, single slices of meat. A marinade is prepared including dark brown sugar, liquid smoke, worcestershire sauce, clover honey, a hot sauce, and a teriyaki sauce. The whole, single slices of meat are marinated for a predetermined amount of time and temperature in a refrigerator. The marinated whole, single slices of meat are flavored with one of multiple flavoring agents, for example, black pepper, cayenne pepper, jalapeno pepper, sriracha, lemon pepper, garlic, herbs, a barbeque spice blend powder, etc., to obtain the corresponding flavoring agent flavor. The marinated and flavored whole, single slices of meat are cooked in a cooking appliance at a predetermined temperature for a predetermined amount of time. The cooked whole, single slices of meat are then cooled to room temperature to produce whole, single slices of meat jerky.

### CROSS-REFERENCE TO RELATED APPLICATIONS

This application claims priority to and the benefit of provisional patent application No. 62/197,590 titled “Preparation And Packaging Of Meat Jerky”, filed in the United States Patent and Trademark Office on Jul. 28, 2015. The specification of the above referenced patent application is incorporated herein by reference in its entirety.

### BACKGROUND

Dried or dehydrated meat products referred in the art as jerky products are a popular snack food and gift item enjoyed by consumers. The popularity of jerky products among the consumers has increased over time. Jerky products are now shipped overseas and marketed in foreign countries including Canada, Europe, Japan, etc.

There are multiple methods for producing jerky products. In one conventional method, jerky products are prepared from ground meat. In this method, meat is ground to a desired consistency and blended with selected ingredients, for example, preservatives, curing agents, binding agents, and a combination of flavoring agents to combine the ground meat and enhance the taste of a jerky product. The ground and blended mixture is then suitably cured for a predetermined amount of time and solidified by freezing for producing a loaf of meat that can be cut into slices. The slices of meat are dried or dehydrated in a drying chamber or a dehydrator, and in some cases, dehydration is performed by heating in oil or fat in a vacuum to produce edible jerky products. This method is time consuming as it requires a freezing step to solidify the meat dough into a loaf of meat.

In another conventional method, a rotary molder is used to produce jerky products. In this method, extruded meat dough is produced by blending ground meat components with selected preservatives, curing agents, and flavoring agents. The extruded meat dough is fed to the rotary molder to produce meat pieces in a desired shape. The meat pieces are dried or dehydrated to produce edible jerky products. Slicing the extruded meat dough typically requires the extruded meat dough to be in a solid state, which may be achieved by chilling or freezing the extruded meat dough. Although this method facilitates accurate slicing of the extruded meat dough, the texture of the jerky product may be undesirable as the jerky product crumbles easily or results in products that look machine-made.

Hence, there is long felt need for a method for preparing whole, single slices of meat jerky having a distinctive and rugged texture with a unique flavor and taste in the least amount of time without complex machinery.

### SUMMARY OF THE INVENTION

This summary is provided to introduce a selection of concepts in a simplified form that are further disclosed in the detailed description of the invention. This summary is not intended to determine the scope of the claimed subject matter.

The method disclosed herein addresses the above recited need for preparing whole, single slices of meat jerky having a distinctive and rugged texture with a unique flavor and taste in the least amount of time without complex machinery. In the method disclosed herein, meat jerky is prepared as follows. A whole slab of raw meat, for example, beef, about 10 pounds (lb) to about 15 lb in weight, is sliced into multiple whole, single slices of meat about 1/16 inches to about ⅛ inches thick. A marinade for marinating the whole, single slices of meat is prepared. For a 10 lb slab of meat, the marinade comprises about 1 lb of dark brown sugar, about 0.0625 lb of liquid smoke, about 0.0625 lb of worcestershire sauce, about 0.875 lb of clover honey, about 0.0625 lb of hot sauce, and about 4.25 lb of one or more teriyaki sauces, where the percent weight of each ingredient of the marinade is based on the total weight of the whole, single slices of meat, that is, the total weight of the raw meat used to prepare a batch of the meat jerky.

The whole, single slices of meat are immersed in the marinade one piece at a time and stirred in the marinade after the addition of each whole, single slice of meat to ensure that each whole, single slice of meat is coated with the marinade, and then the whole, single meat slices are allowed to marinate in the marinade for about 6 hours to about 10 hours at about 40° F. to about 55° F. in a refrigerator. About 0.004 lb of each of the following flavoring agents are made: black pepper, cayenne pepper, chili powder, jalapeno juice, jalapeno pepper, sriracha, lemon pepper, garlic, herbs, a barbeque spice blend powder, etc. After the marination process, the whole, single slices of meat are brushed with one of the above flavoring agents, the flavor of which is to be imparted to the meat jerky. The percent weight of the flavoring agent is based on the weight of the raw meat used to prepare the batch of the meat jerky. The marinated and flavored whole, single slices of meat are cooked in a dehydrator at about 140° F. to about 160° F. for about 12 hours to about 15 hours, depending on thickness of the whole, single slices of meat. In an embodiment, the marinated and flavored, whole single slices of meat are cooked in an electric oven or a non-electric gas oven at about 200° F. to about 225° F. for about 3 hours to about 6 hours, depending on the thickness of the whole, single slices of meat. The cooked whole, single slices of meat are cooled for about 0.5 hours to about 1.5 hours to room temperature to produce whole, single slices of meat jerky, which are thereafter vacuum sealed in one or more packaging bags using a vacuum sealing machine.

### BRIEF DESCRIPTION OF THE DRAWINGS

The foregoing summary, as well as the following detailed description of the invention, is better understood when read in conjunction with the appended drawing. For the purpose of illustrating the invention, an exemplary construction of the invention is shown in the drawing. However, the invention is not limited to the specific method disclosed herein.

FIG. 1 illustrates a method for preparing meat jerky.

### DETAILED DESCRIPTION OF THE INVENTION

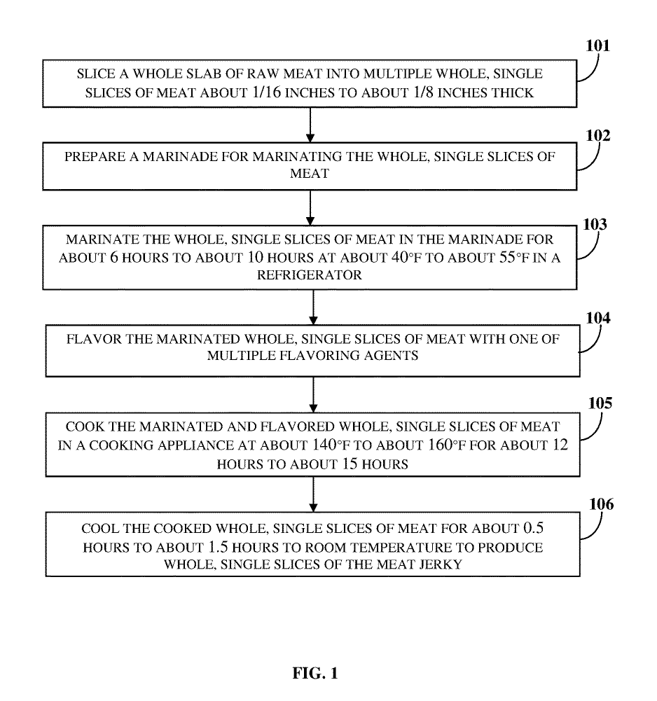

FIG. 1 illustrates a method for preparing meat jerky. Meat jerky can be prepared from different types of meat, for example, beef, lamb meat, goat meat, turkey meat, chicken meat, etc. A whole slab of raw meat of about 10 pounds (lb) to about 15 lb is sliced 101 into multiple whole, single slices of meat (hereafter “single slices of meat”). As used herein, “single slices of meat” refers to unground, single slices of meat sliced from a large, unground whole slab of raw meat. Based on about a 10 lb raw meat jerky batch, a marinade is prepared 102 comprising about 1 lb of dark brown sugar, about 0.0625 lb of liquid smoke, about 0.0625 lb of worcestershire sauce, about 0.875 lb of clover honey, about 0.0625 lb of a hot sauce, and about 4.25 lb of a teriyaki sauce. In an embodiment, based on about a 10 lb raw meat jerky batch, a marinade is prepared comprising about 1 lb of dark brown sugar, about 0.0625 lb of liquid smoke, about 0.0625 lb of worcestershire sauce, about 0.875 lb of honey, about 0.0625 lb of a hot sauce, and about 4.25 lb of a teriyaki sauce.

The dark brown sugar, liquid smoke, and worcestershire sauce are mixed in a container. Then, clover honey, hot sauce, and teriyaki sauce are poured into the container and the ingredients stirred in the container for about 5 minutes by an electric operated stirrer to mix the ingredients of the marinade. The inner surface of the container is scraped manually or by a scraping device to remove any ingredient, for example, honey that adheres to the inner surface of the container. The single slices of meat are marinated 103 for about 6 hours to about 10 hours in the marinade, which is kept in a refrigerator maintained at about 40° F. to about 55° F. The marinated, single slices of meat are flavored 104 by brushing the marinated, single slices of meat with a flavoring agent, the flavor of which is to be imparted to the meat jerky. The marinated, single slices of meat are brushed with, for example, black pepper to provide the flavor for peppered meat jerky, cayenne pepper to provide the flavor for spicy meat jerky, chili powder to provide the flavor for hot and spicy meat jerky, jalapeno juice and jalapeno peppers to provide the flavor for jalapeno flavored meat jerky, sriracha sauce to provide the flavor for sriracha flavored meat jerky, lemon pepper to provide the flavor for lemon pepper flavored meat jerky, garlic to provide the flavor for garlic flavored meat jerky, herb powder to provide the flavor for herb flavored meat jerky, barbeque spice blend powder to provide the flavor for barbeque flavored meat jerky, and the original ingredients of the marinade to provide the flavor for original meat jerky. The marinated and flavored, single slices of meat are cooked 105 in a cooking appliance, for example, a Ronco® dehydrator or a Whirlpool® electric oven at a preset temperature and for a preset time to produce the meat jerky.

In an embodiment, the marinated, single slices of meat are cooked in dehydrators as follows. A Ronco® food dehydrator, model #187-04-0 (hereafter “Ronco® food dehydrator”) is preheated to about 140° F. to about 160° F. The marinated and flavored, single slices of meat are placed on racks without overlapping one another, for example, placed on eight racks made of a metal netted plastic or a net like hard plastic, in a predetermined number of dehydrators, for example, six Ronco® food dehydrators. The marinated and flavored, single slices of meat are cooked in the Ronco® food dehydrator, at about 140° F. to about 160° F. with the air vents of the Ronco® food dehydrator open for about 12 hours to about 15 hours. The cooking time in the Ronco® food dehydrator may be reduced by closing one or more air vents in the Ronco® food dehydrator, which increases the temperature in the Ronco® food dehydrator. Each rack with the marinated and flavored, single slices of meat is rotated within the Ronco® food dehydrator manually in a predefined sequence, for example, about every 4 hours until the marinated and flavored, single slices of meat on the racks are cooked. The predefined sequence for rotating the racks in the Ronco® food dehydrator is selected such that a top rack, after a predefined interval of time, for example, after every four hours, moves to a bottom section of each Ronco® food dehydrator to become a bottom rack.

In an embodiment, the marinated and flavored, single slices of meat are cooked in an oven, for example, a Whirlpool® electric oven, model #RF364PXMQ as follows. The marinated and flavored, single slices of meat are placed without overlapping one another on a cooking surface of the oven. The cooking surface is, for example, a cookie sheet, an oven rack, etc. The marinated and flavored, single slices of meat are cooked at about 200° F. to about 225° F. for about 3 hours depending on the thickness of the single slices of meat, whether the meat is to be cooked rare, medium, or well done, the type of meat, etc.

The honey in the marinade imparts a flavor to the meat jerky and allows the marinated and flavored, single slices of meat to be removed easily off the racks after the marinated and flavored, single slices of meat are cooked in the Ronco® food dehydrator or the Whirlpool® electric oven. The cooked, single slices of meat are then cooled 106 for about 0.5 hours to about 1.5 hours to room temperature to produce individual, single slices of meat jerky. The individual, single slices of meat jerky are then vacuum sealed in one or more packaging bags using a vacuum sealing machine. The individual, single slices of meat jerky are weighed into multiple portions prior to the vacuum sealing of the single slices of meat jerky in one or more packaging bags. Product information comprising, for example, a labeled design, a trademark logo, an expiration date, a government issued certificate or stamp such as the United States Department of Agriculture stamp, founder's information, etc., is stamped on the packaging bags.

An example for preparing and packaging beef jerky is disclosed below.

### Example 1

About a 10 lb whole slab of raw beef is cooled in a refrigerator to about 45° F. and then sliced on a commercial slicer into single slices of raw beef about 1/16 inches to about ⅛ inches thick; the single slices of raw beef are staged in the refrigerator for later use. A marinade is made as follows. About 1 lb of dark brown sugar, for example, Domino® Dark Brown Sugar of Domino Foods Inc., Iselin, N.J. 08830, is poured into about a 3 gallon steel or plastic container. About 0.0625 lb of liquid smoke, for example, Figaro® Hickory Liquid Smoke of Baumer Foods, Inc., Metairie, La. 70001, is poured over the dark brown sugar in the 3 gallon container. The ingredients listed on the container of the Figaro® Hickory Liquid Smoke are as follows: water, hickory smoke flavor, vinegar, hydrolyzed soya protein, sugar, caramel color, and spices. Then, about 0.0625 lb of worcestershire sauce, for example, French's® Worcestershire Sauce of the French's Food Company LLC., Springfield, Mo., is poured over the dark brown sugar and the liquid smoke in the 3 gallon container, and the dark brown sugar, the liquid smoke, and the worcestershire sauce are mixed in the 3 gallon container till the dark brown sugar dissolves in the liquid smoke and the worcestershire sauce. Then, the following ingredients are added to the 3 gallon container: about 0.875 lb of clover honey, for example, Great Value® Clover Honey, Wal-Mart Stores, Inc., Bentonville, Ariz.; about 0.0625 lb of a hot sauce, for example, Louisiana's Pure Hot Sauce, Metairie, La. 70001; and about 4.25 lb of a teriyaki sauce, for example, KIKKOMAN® Teriyaki marinade and sauce of Kikkoman Corporation, Walworth, Wis. 53184. In an embodiment, the clover honey may be substituted with a generic brand honey with no flavor, or any other flavor. The above ingredients are blended in the 3 gallon container with an electric mixer for about 5 minutes. Any honey adhering to the sides and bottom of the 3 gallon container are scraped off manually and blended with the marinade batch in the 3 gallon container. The single slices of raw beef from the refrigerator are immersed in the marinade in the 3 gallon container, one piece at a time, and stirred in the marinade after the addition of each slice of the raw beef to ensure that each single slice of the raw beef is coated with the marinade. The entire batch of the single slices of raw beef in the 3 gallon container is allowed to marinate for about 6 hours to about 10 hours in a refrigerator at about 40° F. to about 55° F., depending on the thickness of the single slices of raw beef, the meat being marinated, and the extent of marination required.

About 0.004 lb of each of the following flavoring agents are made: crushed black pepper, crushed cayenne pepper, chili powder, jalapeno juice, jalapeno pepper, sriracha, lemon pepper, garlic, herbs, a barbeque spice blend powder, etc. Depending on the flavor to be imparted to the marinated, single slices of beef, the marinated single slices of beef are brushed with, for example, black pepper to provide the pepper flavor for the peppered beef jerky, cayenne pepper to provide the hot flavor for the hot and spicy beef jerky, chili powder to provide the flavor for the hot and spicy beef jerky, jalapeno juice and jalapeno peppers to provide the flavor for the jalapeno flavored beef jerky, sriracha sauce to provide the flavor for the sriracha flavored beef jerky, lemon pepper to provide the flavor for the lemon pepper flavored beef jerky, garlic to provide the flavor for the garlic flavored beef jerky, herb powder to provide the flavor for the herb flavored beef jerky, barbeque spice blend powder to provide the flavor for the barbeque flavored beef jerky, and the original blended ingredients to provide the flavor for the original beef jerky. The marinated, single slices of raw beef are placed on racks of the Ronco® food dehydrator or the Whirlpool® electric oven cooking appliance with no overlap between the marinated, single slices of raw beef. The marinated, single slices of raw beef are brushed with one of the flavoring agents, above, the flavor of which is to be imparted to the beef jerky. The Ronco® food dehydrator, model #187-04-0 (hereafter “Ronco® food dehydrator”) is preheated to about 140° F. to about 160° F. in about 30 minutes. Trays containing the marinated and flavored, single slices of raw beef are placed on racks which are positioned inside the Ronco® food dehydrator, and then the marinated and flavored, single slices of beef are cooked in the Ronco® food dehydrator at about 140° F. to about 160° F. with the air vents of the Ronco® food dehydrator open for about 12 hours to about 15 hours. During the cooking period, the racks containing the marinated and flavored, single slices of raw beef are rotated within the Ronco® food dehydrator to ensure the marinated and flavored, single slices of raw beef are cooked more uniformly. In an embodiment, the marinated and flavored, single slices of raw beef are cooked in a Whirlpool® electric oven, model #RF364PXMQ (hereafter “Whirlpool® electric oven”) at about 200° F. to about 225° F. for about 3 hours to about 6 hours. In the embodiment where the marinated and flavored, slices of beef are cooked in the Whirlpool® electric oven, the racks containing the marinated and flavor coated, single slices of raw beef are rotated within the Whirlpool® electric oven to ensure the marinated and flavored, single slices of beef are cooked more uniformly. At the end of the cooking process, the individual single slices of beef jerky are removed from the Ronco® food dehydrator, or from the Whirlpool® electric oven, and allowed to cool to room temperature in about 0.5 hours to about 1.5 hours. The cooled single slices of beef jerky are then vacuum sealed, for example, by a vacuum sealing machine into one or more packaging bags made, for example, of plastic. The vacuum sealed packaging bags are then labeled with the Marjorie's Beef Jerky logo, a universal product code (UPC), the expiration date, founder's information, etc., stamped, and packaged in cases of 24 bags per case.

The beef jerky marinade composition based on about 10 lb of raw beef disclosed in Example 1 above is tabulated below:

| | | Weight of | Ingredient as % by |
|---|---|---|---|
| No. | Ingredient | ingredient | weight of raw beef |
| 1. | Raw beef | About 10 lb | |
| 2. | Dark brown sugar | About 1 lb | About 10% |
| 3. | Liquid smoke | About 0.0625 lb | About 0.625% |
| 4. | Worcestershire sauce | About 0.0625 lb | About 0.625% |
| 5. | Clover honey | About 0.875 lb | About 8.75% |
| 6. | Hot sauce | About 0.0625 lb | About 0.625% |
| 7. | Teriyaki sauce | About 4.25 lb | About 42.5% |
| 8. | Flavoring agent | About 0.004 lb | About 0.04% |

The weight of the ingredients used to make the marinade is proportional to the weight of the raw beef used to make the batch of the beef jerky. For example, if a batch of the beef jerky is made starting with a 15 lb slab of raw beef, the weight of each ingredient listed in the table above will be increased by about 50%. Also, in Example 1, beef may be substituted with any other meat, for example, lamb meat, goat meat, chicken meat, turkey meat, etc.

The foregoing examples have been provided merely for the purpose of explanation and are in no way to be construed as limiting of the method disclosed herein. While the method has been described with reference to various embodiments, it is understood that the words, which have been used herein, are words of description and illustration, rather than words of limitation. Furthermore, although the method has been described herein with reference to particular means, materials, and embodiments, the method is not intended to be limited to the particulars disclosed herein; rather, the method extends to all functionally equivalent structures, methods and uses, such as are within the scope of the appended claims. Those skilled in the art, having the benefit of the teachings of this specification, may effect numerous modifications thereto and changes may be made without departing from the scope and spirit of the method disclosed herein in its aspects.

I claim:

1. A method for preparing meat jerky, the method comprising:
slicing a whole slab of raw meat into a plurality of whole, single slices of meat about 1/16 inches to about ⅛ inches thick;
preparing a marinade for marinating the whole, single slices of meat, the ingredients of the marinade comprising:
about 10% by weight dark brown sugar;
about 0.625% by weight liquid smoke;
about 0.625% by weight worcestershire sauce;
about 8.75% by weight clover honey;
about 0.625% by weight hot sauce; and
about 42.5% by weight teriyaki sauce;
wherein percent weight of each of the ingredients of the marinade is based on weight of the raw meat used to prepare a batch of the meat jerky;
marinating the whole, single slices of meat in the marinade for about 6 hours to about 10 hours at about 40° F. to about 55° F. in a refrigerator;
flavoring the marinated whole, single slices of meat with about 0.04% by weight of one of a plurality of flavoring agents comprising black pepper, cayenne pepper, chili powder, jalapeno juice, jalapeno pepper, sriracha, lemon pepper, garlic, herbs, and a barbeque spice blend powder, wherein percent weight of the one of the flavoring agents is based on the weight of the raw meat used to prepare the batch of the meat jerky;
cooking the marinated and flavored whole, single slices of meat in a cooking appliance at about 140° F. to about 160° F. for about 12 hours to about 15 hours depending on thickness of the whole, single slices of meat; and
cooling the cooked whole, single slices of meat for about 0.5 hours to about 1.5 hours to room temperature to produce whole, single slices of the meat jerky.

2. The method of claim 1, further comprising scraping an inner surface of a container to minimize adherence of any ingredient of the marinade to the inner surface of the container.

3. The method of claim 1, wherein the cooking of the marinated and flavored whole, single slices of meat comprises:
placing one or more of the marinated and flavored whole, single slices of meat without overlapping the marinated and flavored whole, single slices of meat on a predetermined number of racks in a predetermined number of dehydrators heated to a predetermined temperature for a predetermined amount of time;
closing one or more air vents of each of the dehydrators for maintaining a maximum temperature in the each of the dehydrators and reducing time for the cooking of the placed one or more of the marinated and flavored whole, single slices of meat; and
rotating each of the racks of the each of the dehydrators with the placed one or more of the marinated and flavored whole, single slices of meat in a predefined sequence, at predetermined intervals of time until the placed one or more of the marinated and flavored whole, single slices of meat are cooked.

4. The method of claim 3, wherein the racks of the dehydrators are made of one of a metal netted plastic and a net like hard plastic.

5. The method of claim 1, wherein the cooking of the marinated and flavored whole, single slices of meat comprises:
placing the marinated and flavored whole, single slices of meat without overlapping the marinated and flavored whole, single slices of meat on a cooking surface of an oven; and
heating the oven to a predetermined temperature for a predetermined amount of time for the cooking of the placed, marinated and flavored whole, single slices of meat.

6. The method of claim 1, wherein the cooking appliance is one of a dehydrator, an electric oven, and a non-electric oven.

7. The method of claim 1, further comprising vacuum sealing the produced whole, single slices of the meat jerky in one or more packaging bags using a vacuum sealing machine.

8. The method of claim 7, further comprising stamping product information on the one or more packaging bags.

9. The method of claim 1, further comprising weighing the produced whole, single slices of the meat jerky into a plurality of portions prior to vacuum sealing the produced whole, single slices of the meat jerky in one or more packaging bags using a vacuum sealing machine.

10. A method for preparing meat jerky, the method comprising:
slicing a whole slab of raw meat into a plurality of whole, single slices of meat;
preparing a marinade for marinating the whole, single slices of meat, ingredients of the marinade comprising dark brown sugar, liquid smoke, worcestershire sauce, honey, hot sauce, and teriyaki sauce, wherein percent weight of each of the ingredients of the marinade is based on weight of the raw meat used to prepare a batch of the meat jerky;
marinating the whole, single slices of meat in the marinade for about 6 hours to about 10 hours at about 40° F. to about 55° F. in a refrigerator;
flavoring the marinated whole, single slices of meat with one of a plurality of flavoring agents comprising black pepper, cayenne pepper, chili powder, jalapeno juice, jalapeno pepper, sriracha, lemon pepper, garlic, herbs, and a barbeque spice blend powder, wherein percent weight of the one of the flavoring agents is based on weight of the raw meat used to prepare the batch of the meat jerky;
cooking the marinated and flavored whole, single slices of meat in a cooking appliance at about 140° F. to about 160° F. for about 12 hours to about 15 hours depending on thickness of the whole, single slices of meat; and
cooling the cooked whole, single slices of meat for about 0.5 hours to about 1.5 hours to room temperature to produce whole, single slices of the meat jerky.
